(19) United States
(12) Patent Application Publication
(10) Pub. No.: US 2025/0220469 A1
(43) Pub. Date: Jul. 3, 2025

(54) GROUP DEVICE SIGNALING TO COMPENSATE FOR OUTDATED INFORMATION IN A NON-TERRESTRIAL NETWORK (NTN)

(71) Applicant: LENOVO (SINGAPORE) PTE LIMITED, Singapore (SG)

(72) Inventors: Sher Ali CHEEMA, Ilmenau (DE); Seyedomid TAGHIZADEH MOTLAGH, Oberursel (DE); Majid GHANBARINEJAD, Chicago, IL (US); Ali Ramadan ALI, Kraiburg am Inn (DE)

(21) Appl. No.: 18/848,054

(22) PCT Filed: Mar. 16, 2023
(86) PCT No.: PCT/US2023/064589

§ 371 Date: Sep. 17, 2024

Related U.S. Application Data
(60) Provisional application No. 63/321,528, filed on Mar. 18, 2022.

(51) Int. Cl. H04W 24/08; H04W 84/06

(52) U.S. Cl. CPC H04W 24/08; H04W 84/06

(57) ABSTRACT

Various aspects of the present disclosure relate to a group-signaling framework, where the network, such as a non-terrestrial network (NTN), groups or associates multiple user devices (UEs) and signals the grouped UEs to transmit network-performed channel predictions for various quantities of the network. For example, the network can perform various prediction techniques (AI/ML or other predictions) to compensate for CSI aging of channel quantities in the network, and send prediction outputs by signaling groups of UEs, instead of sending a separate signal to each UE associated with the network.

### CROSS REFERENCE TO RELATED APPLICATIONS

This application claims priority to U.S. Provisional Patent Application No. 63/321,528, filed on Mar. 18, 2022, entitled GROUP DEVICE SIGNALING TO COMPENSATE FOR OUTDATED INFORMATION IN A NON-TERRESTRIAL NETWORK (NTN), which is hereby incorporated by reference in its entirety.

### TECHNICAL FIELD

The present disclosure relates to wireless communications, and more specifically to group device signaling in non-terrestrial networks.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

In non-terrestrial networks (NTNs), satellites and other flying objects or vehicles provide a communication network or wireless communications system. These NTN wireless communications systems include geostationary satellite (GEO) systems, low earth orbit (LEO) systems, or other satellite-based or moving objects, unmanned aerial vehicles (UAVs), high altitude platform systems (HAPS), and/or other air-to ground networks or flying objects. These systems are typically deployed above the earth, at distances from a few hundred meters above the ground (e.g., in the case of UAVs or drones) to hundreds of kilometers or higher (e.g., in the case of GEO communication networks).

### SUMMARY

The present disclosure relates to methods, apparatuses, and systems that support a group-signaling framework, where the network, such as an NTN, groups or associates multiple user devices (UEs) and signals the grouped UEs to transmit network-performed channel predictions for various quantities of the network. For example, the network can perform various prediction techniques (AI/ML or other predictions) to compensate for CSI aging of channel quantities in the network, and send prediction outputs by signaling groups of UEs, instead of sending a separate signal to each UE associated with the network. Therefore, the network can indicate changes in the network to multiple UEs via a group common signaling mechanism, limiting the amount of signaling over the network, among other benefits.

Some implementations of the method and apparatuses described herein may further include grouping multiple user devices based on location information or environment-dependent information for the user devices, predicting values or estimating values assisting prediction for one or more quantities that define channel properties of the non-terrestrial network, and transmitting a common signal to the group of multiple user devices that configures each user device of the multiple user devices with the predicted values or parameters assisting values predicted for the one or more quantities that define the channel properties of the non-terrestrial network.

In some implementations of the method and apparatuses described herein, a base station or network entity transmits the common signal to the multiple user devices over a radio resource control signaling channel between the group of multiple user devices and the base station.

In some implementations of the method and apparatuses described herein, the Network entity transmits the common signal to the multiple user devices over a Downlink Control Information (DCI) channel between the group of multiple user devices and the base station.

In some implementations of the method and apparatuses described herein, the network entity transmits information that identifies an incremental change to apply to a value of one of the quantities that define the channel properties of the non-terrestrial network.

In some implementations of the method and apparatuses described herein, the one or more quantities that define the channel properties of the non-terrestrial network include channel state information (CSI) quantities for a cell of the non-terrestrial network that is associated with a location that includes the group of devices.

In some implementations of the method and apparatuses described herein, the network entity predicts a quantity that defines the channel properties of the non-terrestrial network for each of the user devices at a common location, measures a change in the quantity for each of the user devices at the common location, and groups the user devices that exhibit a similar change in the quantity based on the prediction.

In some implementations of the method and apparatuses described herein, the network entity groups multiple user devices that share common Downlink Control Information (DCI).

In some implementations of the method and apparatuses described herein, the network entity groups multiple user devices that share common channel conditions and assigns a group ID to the group of multiple user devices and where the network entity transmits the common signal to user devices assigned the group ID.

In some implementations of the method and apparatuses described herein, the network entity predicts channel variation over a time period for a cell of the non-terrestrial network and configures multiple changes of the one or more quantities that define the channel properties of the non-terrestrial network for each user device of the multiple user devices.

In some implementations of the method and apparatuses described herein, the network entity receives a report from at least one of the user devices of the group of multiple user devices that includes a prediction of channel variations over time for a cell of the non-terrestrial network and configures multiple changes of the one or more quantities that define the channel properties of the non-terrestrial network for each user device of the multiple user devices.

Some implementations of the method and apparatuses described herein may further include measuring or estimating one or more channel state information quantities for a cell of the non-terrestrial network that is associated with a location that includes the user device and broadcasting a message to other user devices at the location that identifies channel aging information from the measured one or more channel state information quantities and information identifying a prediction model employed by the user device to compensate for channel aging at the user device.

In some implementations of the method and apparatuses described herein, the user device broadcasts the message to the other user devices via a PC5 interface between the user device and the other user devices.

In some implementations of the method and apparatuses described herein, the user device broadcasts the message to the other user devices via a sidelink multi-cast message transmitted to the other user device.

In some implementations of the method and apparatuses described herein, the message broadcast by the user device to other user devices at the location includes the measured or estimated one or more channel state information quantities for the cell and determined rate of change values for the one or more channel state information quantities.

In some implementations of the method and apparatuses described herein, the message broadcast by the user device to other user devices at the location includes a request from the user device to receive information from the other user devices that identifies prediction models employed by the other user devices.

In some implementations of the method and apparatuses described herein, the user device broadcasts the message to other user devices via channel resources associated with the cell that are identified by the network entity.

### BRIEF DESCRIPTION OF THE DRAWINGS

FIGS. 1A-1B illustrate examples of wireless communications systems that support group device signaling to compensate for outdated information in non-terrestrial networks (NTNs) in accordance with aspects of the present disclosure.

FIG. 2 illustrates an example of a block diagram that supports the grouping of user equipment of NTNs in accordance with aspects of the present disclosure.

FIG. 3 illustrates a flowchart of a method that supports signaling a group of UEs within NTNs in accordance with aspects of the present disclosure.

FIG. 4 illustrates a flowchart of a method that supports grouping UEs in accordance with aspects of the present disclosure.

FIGS. 5A-5B illustrate examples of block diagrams that support group messages between user equipment in NTNs in accordance with aspects of the present disclosure.

FIG. 6 illustrates a flowchart of a method that supports broadcasting channel predictions to a group of UEs within NTNs in accordance with aspects of the present disclosure.

FIG. 7 illustrates an example of a block diagram of a user equipment that supports group device signaling to compensate for outdated information in non-terrestrial networks in accordance with aspects of the present disclosure.

### DETAILED DESCRIPTION

Compared to terrestrial networks, NTNs often have higher reliability requirements and thus tend to rely more heavily on accurate channel state information (CSI) feedback or other channel quality information from associated UEs. For example, NTNs can utilize accurate CSI feedback when optimizing network resources provided to the UE (e.g., when the gNB or network gateway of a satellite system schedules the optimal cells or other resources of the NTN for the UE).

However, due to the large distances between UEs and the satellites providing the NTNs, certain issues arise that can prevent accurate or useful CSI reporting or feedback from UEs. GEO systems are often associated with longer transmission delays (RTD), and Doppler effects or other movement affects arise within LEO satellite systems. Because of these and other issues (e.g., UE movement, weather or atmospheric conditions) inherent in NTNs, the CSI feedback from a UE can be out-of-date (e.g., or aged), resulting in performance loss, among other drawbacks.

To avoid using outdated CSI feedback and other channel information when optimizing resources of a network, network system can employ prediction-based techniques to attempt to mitigate the effects of channel aging in NTNs when a UE measures CSI for the networks. For example, an NTN can employ Kalman filtering and/or various AI/ML (artificial intelligence and/or machine learning) based prediction models, frameworks, and/or techniques when predicting values for CSI quantities or properties of a channel or cell of the NTN.

Often, due to movement of satellites (e.g., non-geostationary satellite movement), multiple UEs can experience a common change of beam quantity or other similar quantity changes, especially with moving cells. Further, UEs share a geographical location (e.g., are proximate to one another) can also experience common changes in channel quality indicators (CQIs) and/or precoding matrix indicator (PMI) values due to channel aging, such as when aging is due to larger delays for geo-stationary satellites and/or due to non-geostationary satellite movement, weather phenomenon, and other factors.

As described herein, in some implementations, the systems implement and/or utilize a group-signaling framework, where the network, such as an NTN, groups or associates multiple user devices and signals the grouped UEs to transmit network-performed channel predictions for various quantities of the network. For example, the network can perform various prediction techniques (e.g., AI/ML or other predictions) to compensate for CSI aging of channel quantities in the network, and send prediction outputs by signaling groups of UEs, instead of sending a separate signal to each UE associated with the network.

Therefore, the network can indicate changes (e.g., changes in an MCS (modulating and coding scheme) index) in the network to multiple UEs via a group common signaling mechanism, instead of performing dedicated signaling for each of the UEs, limiting the amount of signaling over the network, among other benefits. For example, the network can identify a change in a value for one or more quantities of the network, and efficiently transmit the differential value (e.g., resulting from channel aging) to multiple UEs via a common signal, among other benefits.

Aspects of the present disclosure are described in the context of a wireless communications system. Aspects of the present disclosure are further illustrated and described with reference to the following device diagrams and flowcharts that relate to predicting channel aging compensation quantities for NTNs.

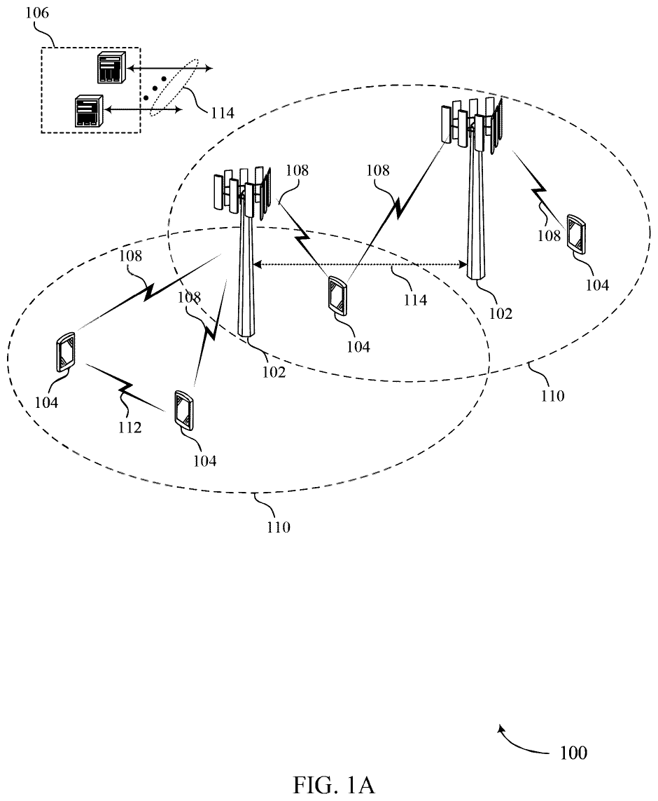

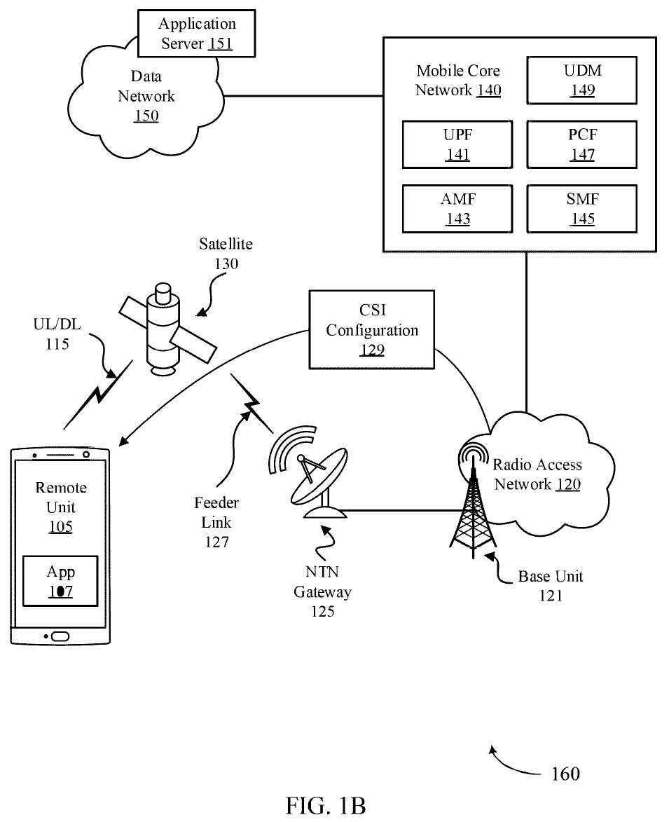

FIG. 1A illustrates an example of a wireless communications system 100 that supports group device signaling to compensate for outdated information in non-terrestrial networks (NTNs) in accordance with aspects of the present disclosure. The wireless communications system 100 may include one or more base stations 102, one or more UEs 104 (or user devices 104), and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

FIG. 1B illustrates another example of a wireless communications system 160 that supports group device signaling to compensate for outdated information in NTNs in accordance with aspects of the present disclosure. The wireless communication system 160 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates via a satellite 130 using wireless communication links 123. As depicted, the mobile communication network includes an “on-ground” base unit 121 which serves the remote unit 105 via satellite access.

In some implementations, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In other implementations, the RAN 120 is compliant with the LTE system specified in the 3GPP specifications. More generally, however, the wireless communication system 160 may implement some other open or proprietary communication network, for example Worldwide Interoperability for Microwave Access (“WiMAX”) or IEEE 802.16-family standards, among other networks.

In some embodiments, the remote units 105 are the user equipment 104 of FIG. 1A and can be referred to as mobile devices or user device. The remote units 105 may communicate directly with one or more of the base units 121 in the RAN 120 via uplink (“UL”) and downlink (“DL”) communication signals. The remote units 105 can communicate in a non-terrestrial network via UL and DL communication signals between the remote unit 105 and a satellite 130.

The satellite 130 may communicate with the RAN 120 via an NTN gateway 125 using UL and DL communication signals between the satellite 130 and the NTN gateway 125. The NTN gateway 125 may communicate directly with the base units 121 in the RAN 120 via UL and DL communication signals. Furthermore, the UL and DL communication signals may be carried over the wireless communication links 123. Here, the RAN 120 is an intermediate network that provides the remote units 105 with access to the mobile core network 140. Moreover, the satellite 130 provides a non-terrestrial network allowing the remote unit 105 to access the mobile core network 140 via satellite access.

While FIG. 1B depicts a transparent NTN system where the satellite 130 repeats the waveform signal for the base unit 121, in other embodiments the satellite 130 (e.g., for a regenerative NTN system), or the NTN gateway 125 (e.g., for an alternative implementation of a transparent NTN system) may also act as base station, depending on the deployed configuration.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120. Note that in the NTN scenario certain RAN entities or functions may be incorporated into the satellite 130. For example, the satellite 130 may be an embodiment of a Non-Terrestrial base station/base unit.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various implementations, the remote unit 105 receives a CSI configuration 129 from the base unit 121, for measurement and reporting of CSI-RS signals. As described in greater detail below, the CSI configuration 129 may contain a mapping table for dynamic adaptions of the CSI measurement behavior, where the remote unit 105 adjusts its frequency/rate of measurement (i.e., measurement periodicity) and/or its frequency/rate of reporting (i.e., reporting periodicity) based on location and/or signal measurement value.

In some implementations, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various implementations, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various implementations, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain implementations, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIGS. 1A-1B depict components of a 5G RAN and a 5G core network, the described technology applies to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for dynamically adapting a measurement behavior.

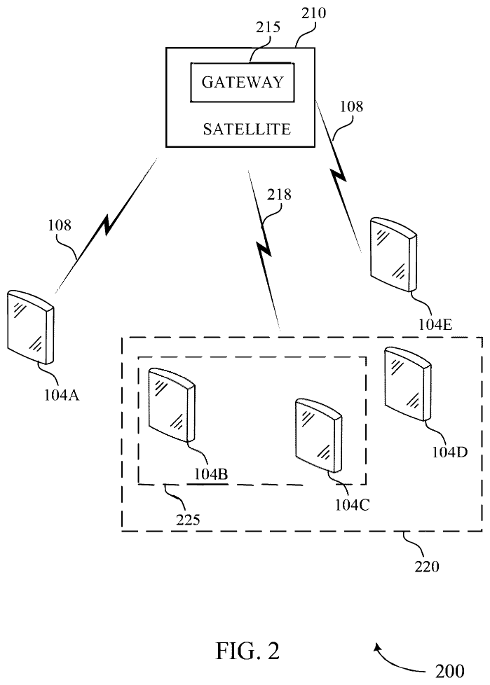

As described herein, the base station 102 or gateway network entity can be moveable, such as when part of a satellite or other flying object associated with an NTN. FIG. 2 illustrates an example of a block diagram that supports the grouping of user equipment of NTNs in accordance with aspects of the present disclosure.

A satellite 210 includes a base station, such as a network gateway 215, and provides an NTN to one or more UEs 104, such as UEs 104A-E. In some implementations, the satellite 210 is part of a GEO system, a LEO system, or other satellite-based or moving object (e.g., unmanned aerial vehicle, or UAV) systems that provide communication services.

As described herein, the network can utilize or employ a group signaling framework, where UEs are grouped together based on a variety of factors (e.g., co-location, common changes, and so on and receive a common signal from the network. For example, UEs 104B, 104C, and 104D are part of a first group 220 based on their location, and UEs 104B and 104C are part of a second group 225 based on a different factor, such as a shared condition experience with respect to a cell of the network.

The network can group the UEs based on a shared location within a cell/beam and/or based on a variety of factors, including a positioning methodology, similar or shared RSRP (Reference Signal Received Power) values, similar or shared spatial filter usage, channel condition, and so on.

The network, as described herein, performs various techniques (e.g., channel averaging, channel predictions) to compensate for outdated or aged network information. For example, the network can apply various AI/ML prediction methods and/or Kalman filtering and can utilize information from the UEs 104A-E when performing the predictions or compensation. The network predicts a new CSI value (e.g., CQI, PMI, RI, and so on) or other quantity values for the UEs 104A-E.

As described herein, because the channel conditions can change in a similar way for co-located UEs (e.g., UEs 104B, 104C, 104D), the resulting quantities (e.g., MCS index quantities) can experience similar changes. Instead of indicating the new quantity to each UE, the network configures a change in the quantity (Δ) to all the UEs experiencing the similar channel conditions (the group 220 of co-located UEs) using a group common signal 218. For example, the network can configure the UEs 104B-104D via common group Downlink Control Information (DCI) and/or common group radio resource control (RRC) signaling.

An example of common group DCI is illustrated in Table 1, where the network uses a pre-defined index corresponding to a quantity when the common DCI is used for multiple quantities, while the network uses a ±Δ with a value to indicate the increment or decrement in the indicated quantities. For example, if the quantity is MCS, then Δ=−1 indicates to decrease the already configured MCS index by one point (e.g., if UE 104B has an MCS of 6, it will use an MCS if 5, and if UE 104C has an MCS of 11, it will use an MCS of 10).

TABLE 1

| Field | Bits |
|---|---|
| Identifier for DCI formats | 0-X |
| Quantity | 0-Y |
| Δ | 0-Z |

In some implementations, the network measures and predicts a quantity for each UE (e.g., for each of the UEs 104A-E). The network then groups the UEs that experience common changes in a quantity and indicates the changes to the grouped UEs (e.g., group 225) via common DCI. For example, the network can employ the common group signal 218 (e.g., common DCI) to indicate a similar change of Δ=±1 to the UE 104B and the UE 104C of the group 225.

In some implementations, the network can signal a group of UEs information that was measured by for a single UE, such as a UE that is part of a network-grouped collection of UEs (e.g., group 220). For example, when the network predicts that a specific aging related compensation for a quantity is required for a single UE (e.g., 104D), or the UE (e.g., 104D) informs the network about a predicted quantity, the network can assume that all the UEs (e.g., UE 104C and 104B) located within the same geographical scattering would experience similar changes, and utilize the common group signal 218 (e.g., common DCI) to configure the co-located UEs with the changes (e.g., the Δ).

In some cases, the network signals the group of UEs via common group DCI, broadcast signaling, and/or multi-cast signaling, where the network indicates a parameter update along with a group ID, and the UEs associated with the group ID receive and enforce the indicated parameter update. Th network can associate a group ID to a group of UEs experiencing a same or similar channel condition, such as a channel aging effect.

For example, the network can assign a shared group ID to all UEs at a location experiencing (or expected to experience) a same change in a weather condition or perceiving the change due to cell/beam mobility. The network can send single parameter updates or multiple parameter update via the broadcast/multi-cast signaling, where the combination of group IDs and parameter updates defines the target group of UEs where each parameter update will take effect.

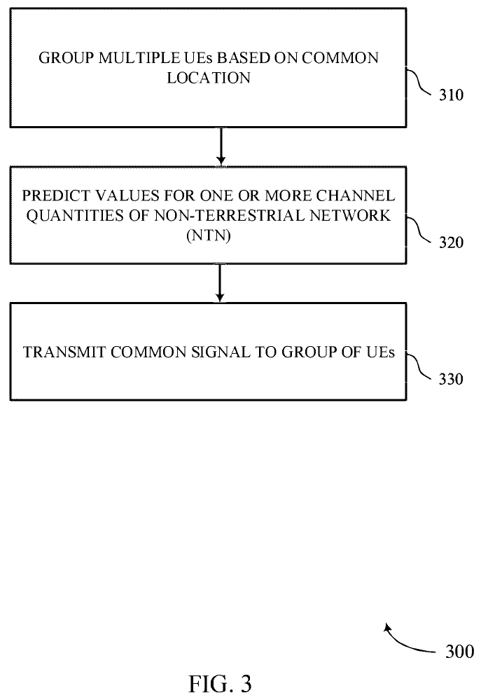

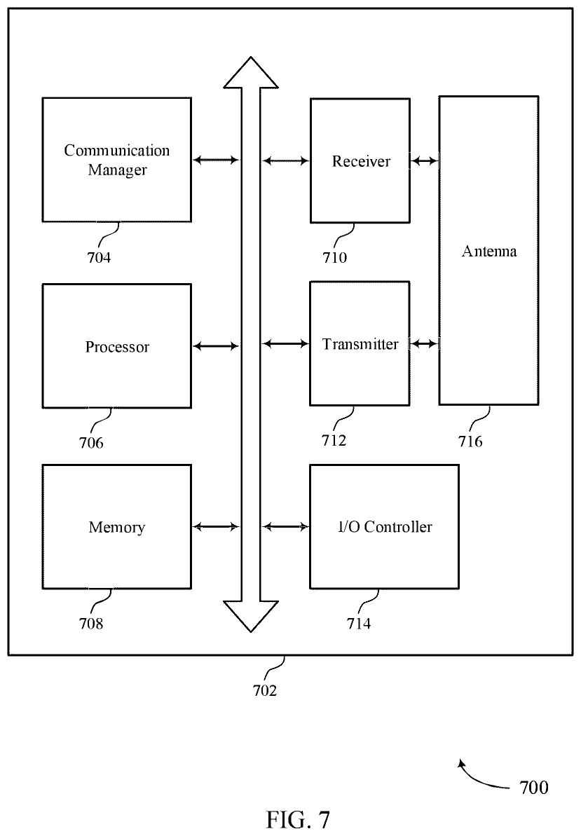

FIG. 3 illustrates a flowchart of a method 300 that supports signaling a group of UEs or user devices within NTNs in accordance with aspects of the present disclosure. The operations of the method 300 may be implemented by a device or its components as described herein. For example, the operations of the method 300 may be performed by a base station 102 as described with reference to FIG. 7. In some implementations, the device may execute a set of instructions to control the function elements of the device to perform the described functions. Additionally, or alternatively, the device may perform aspects of the described functions using special-purpose hardware.

At operation 310, the method may include grouping multiple UEs based on a common location or environmental condition. The operations of step 310 may be performed in accordance with examples as described herein. In some implementations, aspects of the operations of step 310 may be performed by a device as described with reference to FIG. 1.

At operation 320, the method may include predicting values for one or more channel quantities (e.g., CSI) of the NTN. The operations of step 320 may be performed in accordance with examples as described herein. In some implementations, aspects of the operations of step 320 may be performed by a device as described with reference to FIG. 1.

At operation 330, the method may include transmitting a common signal to the group of UEs. The operations of step 330 may be performed in accordance with examples as described herein. In some implementations, aspects of the operations of step 330 may be performed by a device as described with reference to FIG. 1.

In some implementations, the network utilizes various information about the network (e.g., satellite ephemeris, cell layout type (e.g., earth moving or earth fixed), weather phenomenon, UE movement, UE location information, and so on) to predict how a channel or channels vary over a time duration for one or more UEs, such as UEs 104A-E. Further, the UE 104 can predict channel variations over time, and report the information to the network.

Alternatively, UE may also predict channel variations over a time and in its report the validity of the quantities over different time durations. Therefore, based on the network prediction or based on the information received by the UE 104, the network can configure multiple changes (e.g., differential values) in one or more quantities over a time duration to multiple co-located UEs (e.g., group 220) using common group signaling, such as common DCI or common RRC signaling.

When configuring the multiple changes, the network configures multiple differential values for a quantity, along with their applicable durations (e.g., in terms of time units). For example, the network can utilize a field in a common DCI to indicate the changes in a quantity in a sequential manner (Δ₁, Δ₂, . . . , Δ_{M}), and utilize a separate field to indicate the validity of the time duration in a sequential manner (t₁, t₂, . . . , t_{M}), with a one-to-one mapping of the change (Δ) over time, as depicted in Table 2. Using the table, a UE receiving a common DCI can apply the change Δ₁ for the t₁ duration, the change Δ₂ for the t₂ duration, and so on.

TABLE 2
multi-slot triggering of quantities using common DCI

| Field | Bits |
|---|---|
| Identifier for DCI formats | 0-U |
| Quantity | 0-X |
| Δ₁, Δ₂, . . . ,Δ_{M} | {0-Y}₁, {0-Y}₂, . . . ,{0-Y}_{M} |
| t₁, t₂, . . . ,t_{M} | {0-Z}₁, {0-Z}₂, . . . ,{0-Z}_{M} |

Following Table 2, as one first example, the offset between two changes (Δ) is relative to the other. Thus, if a UE is already configured with MCS=9, the UE receives a common DCI with the changes Δ1=−1, Δ2=+2, and Δ3=+1 and the time duration in slots as 2, 4, and 3, the UE first changes (at time 0) its MCS index to 8, at the 2 slot duration changes its MCS index to 10, and after the 4 slot duration changes its MCS index to 11 for the next 3 slots.

As another example, the offset between a change A is relative to a first change Δ. Thus, if the UE is already configured with MCS=9, the UE receives a common DCI with the changes Δ1=−1, Δ2=+2, and Δ3=+1 and time duration in slots as 2, 4, and 3, the UE first changes (at time 0) its MCS index to 8, at the 2 slot duration changes its MCS index to 11, and after 4 slot duration changes its MCS index to 10 for the next 3 slots.

In some cases, the unit of time is not fixed to a slot and instead configured as N number of slots, N subframes, N frames, N milliseconds, N hundreds of milliseconds, and so on. In such cases, tying the signaling to slot duration (instead of the time resolution for CSI changes) ca reduce the signaling overhead of the network when the time resolution for the CSI changes is larger, possibly by orders of magnitudes, than the slot duration.

In some cases, the network can jointly configure the quantity change or differential (Δ) and the associated validity time duration (e.g., Δ₁, t₁, Δ₂, t₂, . . . ) to indicate that the change in quantity is valid for the duration (and instead of separate sequential triggering).

In some implementations, the UE (e.g., the UE 104) can determine the change/update to the channel quantities, such as in response to receiving a message from the network that indicates the configured time duration and the measurements during the configured time duration. In some cases, the quantity update configured by the network is applied at one time step, such as when UE measurements satisfy certain conditions regarding the indicated network quantity over the previous steps. In some cases, the UE computes/determines the quantity of a next step, based on the group/sequence of parameter values configured by the network at the beginning of the time sequence, the performed measurements during the process, the information received from the other UEs, and/or additional non-network information received during the configured period, and so on.

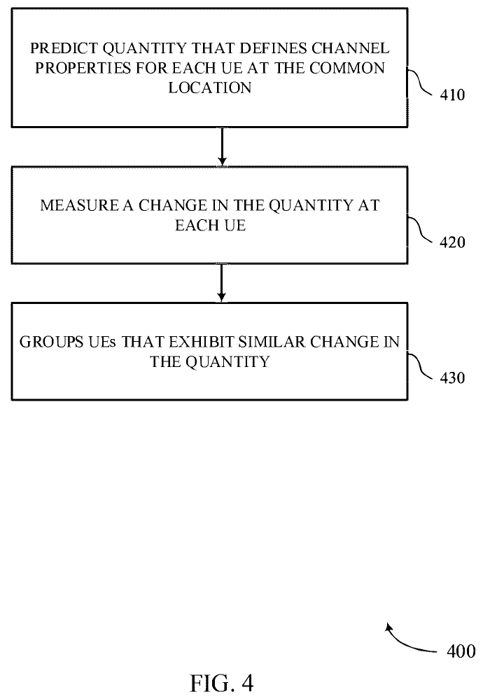

FIG. 4 illustrates a flowchart of a method 400 that supports grouping UEs based on shared changes in CSI quantities in accordance with aspects of the present disclosure. The operations of the method 400 may be implemented by a device or its components as described herein. For example, the operations of the method 400 may be performed by a base station 102 as described with reference to FIG. 7. In some implementations, the device may execute a set of instructions to control the function elements of the device to perform the described functions. Additionally, or alternatively, the device may perform aspects of the described functions using special-purpose hardware.

At operation 410, the method may include predicting a quantity that defines channel properties for each UE at a common location. The operations of step 410 may be performed in accordance with examples as described herein. In some implementations, aspects of the operations of step 410 may be performed by a device as described with reference to FIG. 1.

At operation 420, the method may include measuring a change in the quantity at each of the UEs. The operations of step 420 may be performed in accordance with examples as described herein. In some implementations, aspects of the operations of step 420 may be performed by a device as described with reference to FIG. 1.

At operation 430, the method may include grouping the UEs that exhibit similar changes in the quantity. The operations of step 430 may be performed in accordance with examples as described herein. In some implementations, aspects of the operations of step 430 may be performed by a device as described with reference to FIG. 1.

In some implementations, the network configures the UE to report the measurements during the configured time duration by transmitting the value sequence is transmitted to the UE. The network can change, update, modify, and/or cancel the previously configured value sequence and/or the configured time duration based on the UE measurements, such as when the UE measurements over time indicate the inaccuracy of the network-configured value/prediction.

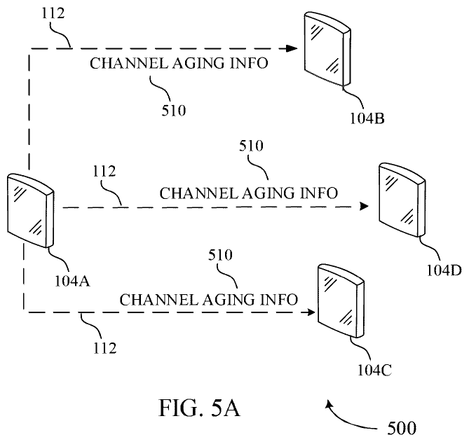

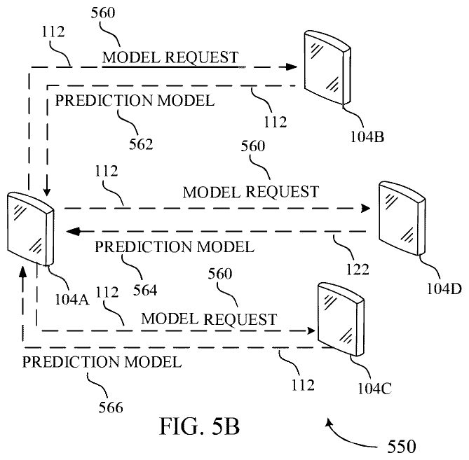

As described herein, in some implementations, the UE 104 can share information, such as information that identifies CSI aging or other outdated channel information, to other UEs, such as UEs at a common geographical location or within a shared cell. FIG. 5A illustrates an example of a block diagram 500 that supports a group message between user equipment in NTNs in accordance with aspects of the present disclosure.

As depicted in FIG. 5A, the UE 104A perform measurements and identifies CSI aging for the NTN. Such information can be useful for co-located UEs, such as UEs 104B, 104C, 104D. The UE 104A sends a message 510 (or message 112 in FIG. 1), such as a sidelink multi-cast message, that includes information elements associated with the performed measurements. The message 510 can indicate the type of channel aging and/or the prediction model utilized to compensate for the channel aging effects. The UE 104 can broadcast the message containing the channel aging via the PC5 interface between the UEs, with some or no assistance from the network.

For example, the information element can include the obtained measurements, rate of change information for a quantity or quantities, differential changes in a certain quantity, weather information, and/or the type of predictive model and its related parameters (e.g., accuracy, weights, and so on), among other information.

In some implementations, the UE 104 can request information from other co-located UEs, such as when the UE is experiencing channel aging or other issues associated with network communications or connectivity. FIG. 5B illustrates an example of a block diagram 550 that supports a UE request between user equipment in NTNs in accordance with aspects of the present disclosure.

As depicted in FIG. 5B, the UE 104A is experiencing channel aging, and sends a broadcast message or multi-cast message 560 to the other UEs (e.g., UEs 104B, 104C, 104D). For example, the UE 104A transmits a sidelink multi-cast message 560 to request information elements from other UEs in its close vicinity that are likely experiencing similar aging phenomenon/conditions. The other UEs 104B-D can transmit messages 562 back to the requesting UE 104A (e.g., over the PC5 interface) provides information associated with channel aging compensation, such as prediction models, their accuracy levels, their prediction values (weights), their experienced rates of change for a quantity, their differential values for channel quantities, and so on.

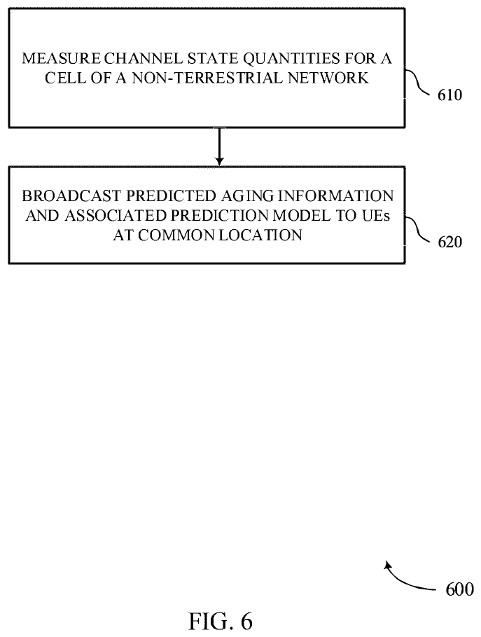

FIG. 6 illustrates a flowchart of a method 600 that supports exchanging messages between UEs (user devices) in accordance with aspects of the present disclosure. The operations of the method 600 may be implemented by a device or its components as described herein. For example, the operations of the method 600 may be performed by the user equipment 104 as described with reference to FIG. 7. In some implementations, the device may execute a set of instructions to control the function elements of the device to perform the described functions. Additionally, or alternatively, the device may perform aspects of the described functions using special-purpose hardware.

At operation 610, the method may include measuring channel state quantities for a cell of an NTN. The operations of step 610 may be performed in accordance with examples as described herein. In some implementations, aspects of the operations of step 610 may be performed by a device as described with reference to FIG. 1.

At operation 620, the method may include broadcasting predicted aging information associated prediction model to other UEs (user devices) at a common location. The operations of step 620 may be performed in accordance with examples as described herein. In some implementations, aspects of the operations of step 620 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

In some cases, the network indicates the channel resources utilized between the UEs when exchanging messages. The network can indicate the configuration of the channel for sidelink message transmission, the type of messages, and/or the occasion of the messages. Further, the network can configure some of the resources utilized during UE messaging and/or not be involved in configuring resources.

FIG. 7 illustrates an example of a block diagram 700 of the device 720, which supports predicting channel aging compensation quantities for non-terrestrial networks (NTNs) in accordance with aspects of the present disclosure. The device 702 may be an example of the UE 104 (or the base station 102, such as the network gateway 215 of the satellite 210), as described herein. The device 702 may support wireless communication with one or more base stations 102, UEs 104, or any combination thereof. The device 702 may include components for bi-directional communications including components for transmitting and receiving communications, such as a communications manager 704, a processor 706, a memory 708, a receiver 710, transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication at a first device (e.g., the device 702) in accordance with examples as disclosed herein. The communications manager 704 may be configured as or otherwise support a means for predicting channel aging compensation quantities for non-terrestrial networks (NTNs), as described herein. For example, the communications manager can: group multiple user devices based on location information or environment-dependent information for the user devices, predict values or estimate values assisting prediction for one or more quantities that define channel properties of the non-terrestrial network, and transmit a common signal to the group of multiple user devices that configures each user device of the multiple user devices with the predicted values or parameters assisting values predicted for the one or more quantities that define the channel properties of the non-terrestrial network.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

In addition to supporting wireless communication at a first device, such as the UE 104, the communications manager 704, when implemented as part of the base station 102, can support wireless communication at a second device (e.g., the device 702) in accordance with examples as disclosed herein. The communications manager 704 may be configured as or otherwise support a means for broadcasting prediction information between user devices, as described herein. For example, the communications manager can: measure or estimate one or more channel state information quantities for a cell of the non-terrestrial network that is associated with a location that includes the user device and broadcast a message to other user devices at the location that identifies channel aging information from the measured one or more channel state information quantities and information identifying a prediction model employed by the user device to compensate for channel aging at the user device.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A network entity of a non-terrestrial network, the network entity comprising:
at least one memory; and
at least one processor coupled with the at least one memory and configured to cause the network entity to:
group user devices based on location information or environment-dependent information for the user devices;
predict values or estimate values assisting prediction for one or more quantities that define channel properties of the non-terrestrial network; and
transmit a common signal to the grouped user devices that configures each user device of the grouped user devices with the predicted values or parameters assisting values predicted for the one or more quantities that define the channel properties of the non-terrestrial network.

2. The network entity of claim 1, wherein the common signal comprises a group-common radio resource control (RRC) signal.

3. The base station of claim 1, wherein the common signal comprises a group-common downlink control information (DCI).

4. The network entity of claim 1, wherein the at least one processor is further configured to cause the network entity to transmit information that identifies an incremental change to apply to a value of one of the one or more quantities that define the channel properties of the non-terrestrial network.

5. The network entity of claim 1, wherein the one or more quantities that define the channel properties of the non-terrestrial network include channel state information (CSI) quantities for a cell of the non-terrestrial network associated with a location that includes the grouped user devices.

6. The network entity of claim 1, wherein the at least one processor is further configured to cause the network entity to:
predict a quantity that defines the channel properties of the non-terrestrial network for each user device of the grouped user devices at a common location; and
measure a change in the quantity for each user device grouped of the user devices at the common location;
wherein the grouped user devices are grouped based on the measured change in the quantity for each user device of the grouped user devices.

7. The network entity of claim 1, wherein the at least one processor is further configured to cause the network entity to group multiple user devices that share common downlink control information (DCI).

8. The network entity of claim 1, wherein the at least one processor is configured to cause the network entity to group user devices that share common channel conditions and assigns a group identifier (ID) to the grouped user devices, and wherein the common signal is transmitted to the grouped user devices based on the assigned group ID.

9. The network entity of claim 1, at least one processor is further configured to cause the network entity to:
predict channel variation over a time period for a cell of the non-terrestrial network; and
configure multiple changes of the one or more quantities that define the channel properties of the non-terrestrial network for each user device of the grouped user devices.

10. The network entity of claim 1, wherein the at least one processor is further configured to cause the network entity to:
receive a report from at least one of the user devices of the grouped user devices that includes a prediction of channel variations over time for a cell of the non-terrestrial network; and
configure multiple changes of the one or more quantities that define the channel properties of the non-terrestrial network for each user device of the grouped user devices.

11. A method performed by a network entity of a non-terrestrial network, the method comprising:
grouping user devices based on location information or environment-dependent information for the multiple user devices;
predicting values or estimate values assisting prediction for one or more quantities that define channel properties of the non-terrestrial network; and
transmitting a common signal to the grouped multiple user devices that configures each user device of the grouped user devices with the predicted values or parameters assisting values predicted for the one or more quantities that define the channel properties of the non-terrestrial network.

12. The method of claim 11, wherein the common signal comprises a group-common radio resource control (RRC) signal.

13. The method of claim 11, wherein the common signal comprises a group-common downlink control information (DCI).

14. (canceled)

15. A user device that communicates with a network entity of a non-terrestrial network, the user device comprising:
at least one memory; and
at least one processor coupled with the at least one memory and, configured to cause the user device to:
measure or estimate one or more channel state information quantities for a cell of the non-terrestrial network that is associated with a location that includes the user device; and
broadcast a message to other user devices at the location that identifies channel aging information from the measured one or more channel state information quantities and information identifying a prediction model employed by the user device to compensate for channel aging at the user device.

16. The user device of claim 15 wherein the at least one processor is configured to cause the user device to broadcast the message to the other user devices via a PC5 interface.

17. The user device of claim 15, wherein the at least one processor is configured to cause the user device to broadcast the message to the other user devices via a sidelink multi-cast message.

18. The user device of claim 15, wherein the message broadcast by the user device to other user devices at the location includes the measured or estimated one or more channel state information quantities for the cell and determined rate of change values for the one or more channel state information quantities.

19. The user device of claim 15, wherein the message broadcast by the user device to other user devices at the location includes a request from the user device to receive information from the other user devices that identifies prediction models employed by the other user devices.

20. The user device of claim 15 wherein the at least one processor is configured to cause the user device to broadcast the message to other user devices via channel resources associated with the cell that are identified by the network entity.

21. A processor for wireless communication, comprising:
at least one controller coupled with at least one memory and configured to cause the processor to:
measure or estimate one or more channel state information quantities for a cell of a non-terrestrial network that is associated with a location that includes the processor; and
broadcast a message to user devices at the location that identifies channel aging information from the measured one or more channel state information quantities and information identifying a prediction model employed by the processor to compensate for channel aging at the processor.
